(19) United States
(12) Patent Application Publication
(10) Pub. No.: US 2026/0219365 A1
(43) Pub. Date: Jul. 30, 2026

(54) OPTICAL SYSTEM DEVICES

(71) Applicant: SCIVAX CORPORATION, Kawasaki-shi, Kanagawa (JP)

(72) Inventors: Akifumi NAWATA, Kawasaki-shi, Kanagawa (JP); Satoru TANAKA, Kawasaki-shi, Kanagawa (JP)

(73) Assignee: SCIVAX CORPORATION, Kawasaki-shi, Kanagawa (JP)

(21) Appl. No.: 19/143,145

(22) PCT Filed: Dec. 26, 2023
(86) PCT No.: PCT/JP2023/046826

§ 371 Date: Jun. 25, 2025

(30) Foreign Application Priority Data
Dec. 27, 2022 (JP) 2022-210171

(51) Int. Cl. G01S 7/481; G01S 17/894; G02B 3/00; G02B 3/04; G02B 27/00

(52) U.S. Cl. CPC G01S 7/4814; G01S 17/894; G02B 3/005; G02B 3/04; G02B 27/0012; G02B 2003/0093

(57) ABSTRACT

The present disclosure provides an optical system device including an optical element comprising a plurality of aspherical lenses each allowing light with a wavelength λ to pass therethrough, the plurality of aspherical lenses being arranged at intervals; and a light emitting unit comprising a light source that emits the light with the wavelength λ to the plurality of lenses.

### TECHNICAL FIELD

The present disclosure relates to an optical system device.

### BACKGROUND ART

Three-dimensional measurement sensors that utilize a Time Of Flight (TOF) scheme are now to be applied to portable devices, vehicles, and robots, etc. such a sensor measures a distance from an object based on a time until light emitted by a light source to an object is reflected and returns. When light from the light source is emitted uniformly to the predetermined region of the object, the distance at each point subjected to light emission can be measured, and thus the three-dimensional structure of the object can be detected.

The above-described sensor system includes a light emitting unit that emits light to an object, a camera unit that detects reflected light from each point on the object, and an arithmetic unit that calculates a distance from the object in accordance with a signal according to the light received by the camera unit.

As for the camera unit and the arithmetic unit, already-existing CMOS imager and CPU are applicable, respectively, and thus the unique component of the above-described system is the light emitting unit that includes a laser and an optical filter. In particular, the distinguishing component of the above-described system is a diffusing filter which shapes a beam by causing laser light to pass through a microlens array, and which cause the light to be emitted uniformly within a controlled region to an object.

Conventional diffusing filters have a technical problem such that the variability occurs in light intensity due to the adverse effect of diffraction since the microlens array employs a periodic structure. Hence, in order to suppress such a variability, an attempt such as to place each lens at random is made (e.g., Patent Document 1).

Conversely, the TOF has needs for long-distance measurement, and emitted light needs an intensity that enables such a long-distance measurement. However, since the microlens array having undergone the random placement has the high uniformity of emitted light but decreases the intensity thereof, it is not suitable for such a long-distance measurement.

Hence, as for a scheme capable of processing intensive light signals while saving electric power, a scheme to emit a dot pattern and to execute a three-dimensional measurement from the Time Of Flight of such light is now examined.

Conventionally, an optical system device that converts incident light into a dot pattern by utilizing the Lau effect is known (e.g., Non-patent Document 1). This includes a diffraction grating with a predetermined pitch P, and a light source, and when the wavelength of light from the light source is defined as λ, and n is a natural number that is greater than or equal to 1, placement is made in such a way that a distance L₀ between the diffraction grating and the light source satisfies the following formula A.

$$\begin{matrix}[ Mathematical Expresion 1 ] & \\ {L}_{0} = \frac{{nP}^{2}}{2 λ} & ( Formula A )\end{matrix}$$

Moreover, replacement of the diffraction grating with a microlens is now also examined (e.g., Patent Document 2).

### CITATION LIST

### Patent Literatures

Patent Document 1: JP 2006-500621A
Patent Document 2: WO 2017/131585A
Non-patent Document 1: H. Hamam, Lau Array Illuminator, Applied Optics, 43(14): 2888-2894, May 10, 2004.

### SUMMARY OF INVENTION

### Technical Problem

Upon keen researches and examinations by the inventors of the present disclosure, it becomes clear that, when a diffraction grating is replaced with a microlens, lights are further intensified when, instead of the distance L₀ between the microlens and the light source, a distance L between the focal plane of the microlens and the light source satisfies the following formula B (e.g., Japan Patent Application No. 2021-137560).

$$\begin{matrix}[ Mathematical Expresion 2 ] & \\ {L}_{0} = \frac{{nP}^{2}}{2 λ} & ( Formula B )\end{matrix}$$

In such an optical system device, when it is desired to make a dot pattern in a circular shape, a spherical lens is applied, and when it is desired to make it in a non-circular shape, an aspherical lens is applied.

According to such an optical system device, however, it becomes clear that, when an aspherical lens is applied to an optical element, in comparison with a case in which a spherical lens is applied, the contrast decreases. This is because the cross-sectional shape of the lens varies depending on the directions in the case of the aspherical lens, the focal distance by the cross-sectional shape varies in each direction, and thus a difference occurs between an apparent focal distance where lights are concentrated by the aspherical lens and the actual focal distance.

Regarding this fact, a simulation using an optical simulation software BeamPROP (available from Synopsys, Inc.) was carried out. As for a light emitting unit, a single light source 7 that emits light which has a wavelength that is 940 nm (λ=0.94) and which has a light distribution as illustrated in FIGS. 1A and B was applied. As for an optical element 8, as illustrated in FIGS. 2A and B, one that has aspherical lenses 81 each having a refractive index which is 1.53 arranged tetragonally at intervals so as to have a pitch P that is 32 μm (P=32) was applied. As for the aspherical lens 81, as illustrated in FIG. 2C, one which is formed in a square shape with a length of each side in a planar shape of an Xy plane that is 32 μm, and which has a height that is 21.2 m was applied. Although the focal distance of the aspherical lens 81 is 50 μm, a focal distance f₁ by the cross-sectional shape of the aspherical lens 81 perpendicular to the y-direction is 10 μm, and a focal distance f₂ by the cross-sectional shape perpendicular to the x-direction is 80 μm. A distance L_{δ} between the optical element and the light source 7 was set to be the following formula C (where n=2). More specifically, the distance between the optical element 8 and the light source 7 was set to be 1089+δ μm.

$$\begin{matrix}[ Mathematical Expresion 3 ] & \\ {L}_{δ} = \frac{{nP}^{2}}{2 λ} + δ & ( Formula C )\end{matrix}$$

FIG. 3 shows a simulation result regarding a contrast ratio when light from the light source was emitted to the optical element while changing δ 10 μm by 10 μm from 10 to 90 μm. Moreover, FIG. 4 are each a projected drawing by the simulation when light from the light source was emitted to the optical element with A: δ=10 μm, B: δ=50 μm, and C: S=80 μm.

As shown in FIG. 4A, when δ=10 μm, a distance L between the focal plane by a cross-sectional shape of the aspherical lens perpendicular to the y-direction and the light source satisfies the formula B, but the distance L between a focal plane by the cross-sectional shape perpendicular to the x-direction and the light source does not satisfy the formula B, and thus dots become a shape extended in the y-direction. Moreover, as shown in FIG. 4C, when δ=80 μm, the distance L between the focal plane by the cross-sectional shape of the aspherical lens perpendicular to the x-direction and the light source satisfies the formula B, but the distance L between the focal plane by the cross-sectional shape perpendicular to the y-direction and the light source does not satisfy the formula B, and thus dots become a shape extended in the x-direction. Furthermore, as shown in FIG. 4B, when δ=50 μm, dots become a circular shape, but since the distance L between the focal plane by the cross-sectional shape on the xz plane and the light source, and, the distance L between the focal plane by the cross-sectional shape on the yz plane and the light source both do not satisfy the formula B, as shown in FIG. 3, the contrast decreases in comparison with cases in which δ=10 μm and δ=80 μm.

As described above, as for conventional optical system devices, a difference in focal distance due to a difference in the direction of an aspherical lens is not taken into consideration.

Hence, an objective according to the present disclosure is to provide an optical system device capable of emitting high-contrast light even when emitting a non-circular dot pattern.

### SOLUTION TO PROBLEM

In order to accomplish the above objective, an optical system device according to the present disclosure includes:
an optical element including a plurality of aspherical lenses each allowing light with a wavelength λ to pass therethrough, the plurality of aspherical lenses being arranged at intervals; and
a light emitting unit including a light source that emits the light with the wavelength λ to the plurality of lenses,
in which when m and n are each a natural number that is greater than equal to 1, f₁ is a focal distance by a cross-sectional shape of the aspherical lens perpendicular to a y-direction, f₂ is a focal distance by a cross-sectional shape of the aspherical lens perpendicular to an x-direction (f₁≠f₂), P₁ is a dimension of a pitch of the aspherical lens in the x-direction, and P₂ is a pitch of the aspherical lens in the y-direction, a distance L₁ between the light emitting unit and a first focal plane of the aspherical lens, and a distance L₂ to a second focal plane thereof satisfy the following formula 1 and formula 2, respectively.

$$\begin{matrix}[ Mathematical Expresion 1 ] & \\ \frac{{mP}_{1}^{2}}{2 λ} - {f}_{1} < {L}_{1} < \frac{{mP}_{1}^{2}}{2 λ} + {f}_{1} & ( Formula 1 )\end{matrix}$$

$$\begin{matrix}[ Mathematical Expresion 2 ] & \\ \frac{{nP}_{2}^{2}}{2 λ} - {f}_{2} < {L}_{2} < \frac{{nP}_{2}^{2}}{2 λ} + {f}_{2} & ( Formula 2 )\end{matrix}$$

Moreover, it is preferable that a plurality of the light sources of the light emitting unit should be arranged with a dimension of a pitch in the x-direction that is Pₓ, and a dimension of a pitch in the y-direction that is P_{y}, and when j and λ are each a natural number that is greater than or equal to 1, Pₓ=jP₁ or jPₓ=P₁ should be satisfied and P_{y}=kP₂ or kP_{y}=P₂ should be satisfied.

It is preferable that the distances L₁ and L₂ should satisfy the following formula 3 and formula 4, respectively.

$$\begin{matrix}[ Mathematical Expresion 3 ] & \\ {L}_{1} = \frac{{mP}_{1}^{2}}{2 λ} & ( Formula 3 )\end{matrix}$$

$$\begin{matrix}[ Mathematical Expresion 4 ] & \\ {L}_{2} = \frac{{nP}_{2}^{2}}{2 λ} & ( Formula 4 )\end{matrix}$$

Moreover, it is preferable that a planar shape of the lens is a rectangular shape or a hexagonal shape.

### Advantageous Effects of Invention

The optical system device according to the present disclosure can emit high-contrast light.

### BRIEF DESCRIPTION OF DRAWINGS

FIG. 1 are each a diagram illustrating a distributed light distribution of a light emitting unit at a distant field which was applied for a simulation;

FIG. 2 illustrate a conventional optical system device, and A is a schematic cross-sectional view by an xz plane, B is a schematic cross-sectional view by a yz plane, and C is a perspective view illustrating an aspherical lens;

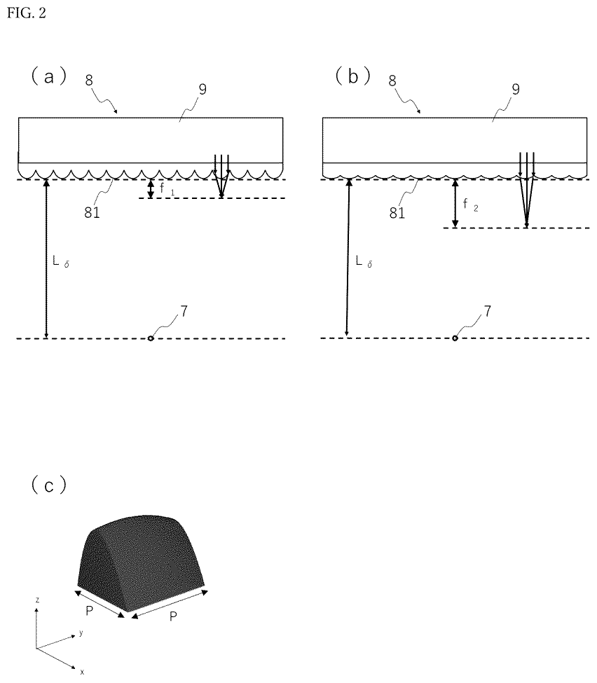

FIG. 3 is a graph showing a contrast by the conventional optical system device;

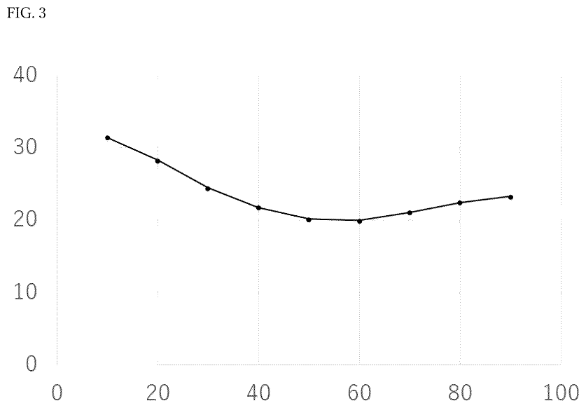

FIG. 4 are each a projection diagram of a dot pattern by the conventional optical system device;

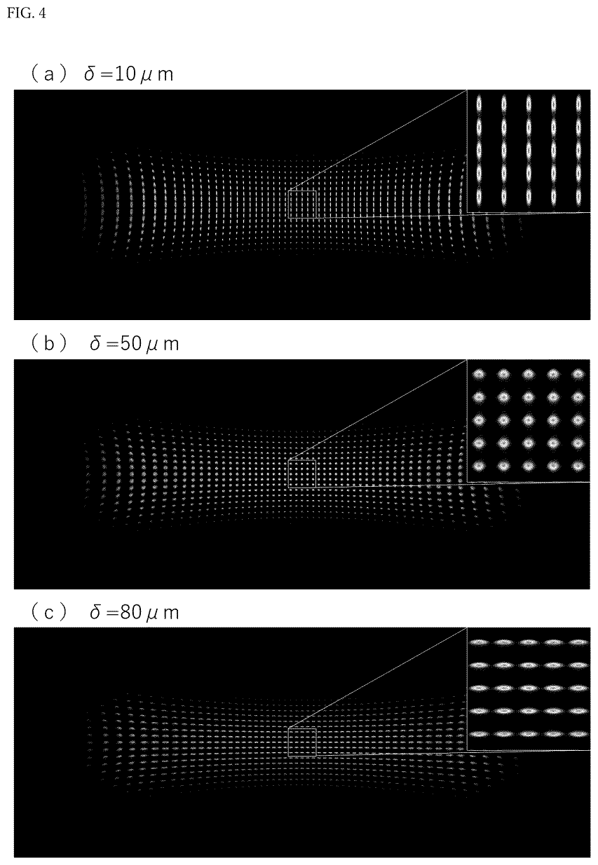

FIGS. 5A and B are each a schematic cross-sectional view illustrating an optical system device according to the present disclosure, and C is a perspective view illustrating an aspherical lens;

FIG. 6 is a projection diagram of a dot pattern by the optical system device according to the present disclosure; and

FIG. 7 are each a schematic cross-sectional view illustrating a production method for an optical element according to the present disclosure.

### DESCRIPTION OF EMBODIMENTS

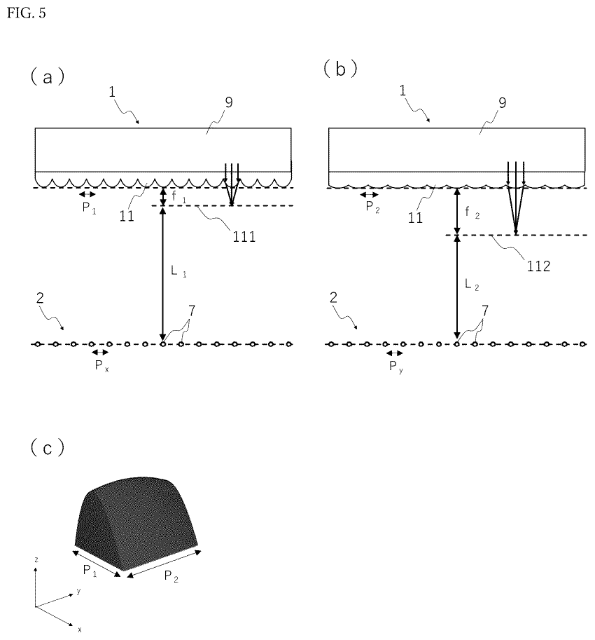

An optical system device according to the present disclosure will be described below. As illustrated in FIGS. 5, the optical system device according to the present disclosure mainly includes an optical element 1 and a light emitting unit 2. In this example, with directions perpendicular to one another being defined as an x-direction, a y-direction, and z-direction, and the optical-axis direction of the optical element 1 being defined as the z-direction, FIG. 5A is a diagram when the optical system device is viewed in the y-direction, and FIG. 5B is a diagram when the optical system device is viewed in the x-direction.

As illustrated in FIGS. 5, the optical element 1 includes aspherical lenses 11 through which light mainly with a wavelength λ passes and which are arranged at intervals.

The aspherical lens 11 has a focal distance by a cross-sectional shape perpendicular to the y-direction that is f₁, a focal distance by a cross-sectional shape perpendicular to the x-direction that is f₂, a dimension of a pitch in the x-direction that is P₁, and a dimension of the pitch in the y-direction that is P₂. In this example, the aspherical lens 11 has different focal distance f₁ and focal distance f₂ (i.e., f₁≠f₂). Note that the term focal distance in this specification means, as illustrated in FIGS. 5, a distance between the nearest lens surface to a focal point and the focal point. Moreover, the aspherical lens 11 is arranged in such a way that both the focal point by the cross-sectional shape perpendicular to the y-direction and the focal point by the cross-sectional shape perpendicular to the x-direction are located at the light-emitting-unit-2 side of the aspherical lens 11. Furthermore, the optical element according to the present disclosure is applicable to, for example, a wide-angle lens that has the focal distances f₁ and f₂ each being smaller than 20 μm, 15 μm, and 10 μm, or a narrow-angle lens that has such distances each greater than 60 μm, 65 μm, and 70 μm.

The shape of the aspherical lens 11 is not limited to any particular shape, and general lenses, such as a convex lens and a concave lens, and further a Fresnel lens, a DOE lens, and a metalens are applicable. In the case of a convex lens, it is preferable that a convex lens portion should be directed to the light-emitting-unit-2 side. Moreover, the planar shape of the lens may be a rectangular shape or a hexagonal shape. Furthermore, the aspherical lens 11 may be formed with an antireflection film that prevents light from the light emitting unit 2 from being reflected.

Moreover, the material of the aspherical lens is not limited to any particular material, but, for example, a resin or a glass is applicable.

As illustrated in FIGS. 5, the light emitting unit 2 includes a light source 7 that emits light with a wavelength λ to the plurality of aspherical lenses 11. The light source 7 is not limited to any particular light source as far as it can emit light with the wavelength λ to the plurality of aspherical lenses 11. Moreover, the light emitting unit 2 may be a singular light source or a plurality of light sources. Furthermore, light from a singular light source may be caused to pass through an aperture in which a plurality of slits is formed so as to accomplish a plurality of light sources. When the light emitting unit 2 includes the plurality of light sources, it is preferable that such light sources 7 should be formed on the same plane. Still further, the light emitting unit 2 and the optical element 1 may be placed in such a way that the optical-axis direction of the light source of the light emitting unit 2 becomes consistent with the optical-axis direction of the aspherical lens 11 of the optical element 1. A specific example of the light emitting unit 2 is, for example, a Vertical Cavity Surface Emitting LASER (VCSEL) that is expected to accomplish a high output with little electric power. The VCSEL includes the plurally of light source 7 that can emit light in the perpendicular direction to a light emitting surface. Moreover, it is preferable that the light emitting unit 2 should have a light absorption film formed on portions other than the light source 7 since noises by reflected light do not enter.

In a case in which the light emitting unit 2 includes the plurality of light sources 7, it is necessary to place, even the light emitting unit 2 and the optical element 1 are displaced in parallel with each other, such a unit and such an element in such a way that the number of light sources 7 relative to each aspherical lens 11 of the optical element 1 should be consistent in a planar view. Hence, it is preferable that the light sources 7 of the light emitting unit 2 should be arranged at regular intervals so as to satisfy: Pₓ=jP₁ or jPₓ=P₁; and P_{y}=kP₂ or kP_{y}=P₂, where Pₓ is the dimension of the pitch in the x-direction, P_{y} is the dimension of the pitch in the y-direction, and j and λ are each a natural number greater than or equal to 1.

Moreover, when the light sources 7 of the light emitting unit 2 are squarely arranged, as for the optical element 1, the pitch P₁ and pitch P₂ of the aspherical lenses 11 can be set to as P₁=P₂. Furthermore, when the light sources 7 of the light emitting unit 2 are hexagonally arranged, the pitch P₁ and pitch P₂ of the aspherical lenses 11 can be set to as 2P₁=√3P₂ or √3P₁=2P₂.

### [Positional Relation Between Light Emitting Unit and Optical Element]

The optical system device can convert incident light to a dot pattern with a large contrast when, as illustrated in FIGS. 5, a distance L₁ between the light emitting unit 2 and a first focal plane 111 of the aspherical lens 11, and a distance L2 to a second focal plane 112 satisfy the following formulae α and β, respectively. In the following formulae, m and n are each a natural number that is greater than or equal to 1, P₁ is the dimension of the pitch of the aspherical lens 11 in the x-direction, P₂ is the dimension of the pitch of the aspherical lens 11 in the y-direction, λ is the wavelength of incident light from the light emitting unit 2, f₁ is a focal distance by the cross-sectional shape of the aspherical lens 11 perpendicular to the y-direction, f2 is a focal distance by the cross-sectional shape perpendicular to the x-direction (f₁≠f₂), and a, b, c and d are each a coefficient representing an allowable error.

$$\begin{matrix}[ Mathematical Expresion 8 ] & \\ \frac{{mP}_{1}^{2}}{2 λ} - {af}_{1} < {L}_{1} < \frac{{mP}_{1}^{2}}{2 λ} + {bf}_{1} & ( Formula α )\end{matrix}$$

$$\begin{matrix}[ Mathematical Expresion 9 ] & \\ \frac{{nP}_{2}^{2}}{2 λ} - {cf}_{2} < {L}_{2} < \frac{{nP}_{2}^{2}}{2 λ} + {f}_{2} & ( Formula β )\end{matrix}$$

Note that the term first focal plane 111 means a plane which is perpendicular to the optical axis (the z-direction) of the aspherical lens 11, and which is located at a focal position by the cross-sectional shape of the aspherical lens 11 perpendicular to the y-direction. Moreover, the term second focal plane 112 means a plane which is perpendicular to the optical axis (the z-direction) of the aspherical lens 11, and which is located at a focal position by the cross-sectional shape of the aspherical lens 11 perpendicular to the x-direction. Furthermore, the distances L₁ and L₂ each mean a distance (an optical path length) that light travels in vacuum within the same time when travelling in a medium, and are each represented by a product NL, where N is the refractive index of the medium and L is an actual distance.

Moreover, it is preferable that the coefficient a in the formula α should be as small as possible, such as a=1, a=0.5, a=0.3, and a=0.1. In addition, it is preferable that the coefficient b should be as small as possible, such as b=1, b=0.5, b=0.3, and b=0.1. Furthermore, it is preferable that the coefficient c in the formula β should be as small as possible, such as c=1, c=0.5, c=0.3, and c=0.1. In addition, it is preferable that the coefficient d should be as small as possible, such as d=1, d=0.5, d=0.3 and d=0.1. As for the coefficients in the formula β, when a=b=c=d=1, the formula α and the formula β become the following formula 1 and formula 2, respectively.

$$\begin{matrix}[ Mathematical Expresion 10 ] & \\ \frac{{mP}_{1}^{2}}{2 λ} - {f}_{1} < {L}_{1} < \frac{{mP}_{1}^{2}}{2 λ} + {f}_{1} & ( Formula 1 )\end{matrix}$$

$$\begin{matrix}[ Mathematical Expresion 11 ] & \\ \frac{{nP}_{2}^{2}}{2 λ} - {f}_{2} < {L}_{2} < \frac{{nP}_{2}^{2}}{2 λ} + {f}_{2} & ( Formula 2 )\end{matrix}$$

In particular, as for the coefficients in the formula β, when a=b=c=d=0, i.e., when the distances L1 and L2 satisfy the following formula 3 and formula 4, lights can be maximally intensified.

$$\begin{matrix}[ Mathematical Expresion 12 ] & \\ {L}_{1} = \frac{{mP}_{1}^{2}}{2 λ} & ( Formula 3 )\end{matrix}$$

$$\begin{matrix}[ Mathematical Expresion 13 ] & \\ {L}_{2} = \frac{{nP}_{2}^{2}}{2 λ} & ( Formula 4 )\end{matrix}$$

Moreover, when the pitches P1 and P2 become too smaller than the wavelength λ of light from the light source 7, it becomes difficult to cause diffraction. Hence, as far as the sufficient number of aspherical lenses 11 to cause diffraction are present within the light distribution angle of the light source 7, it is preferable that the pitches P1 and P2 should be sufficiently greater than the wavelength λ of light from the light source 7, e.g., greater than or equal to 5 times, preferably, greater than or equal to 10 times.

### [Simulation]

Next, a light intensity distribution at a far field was simulated for a case in which the distance L₁ between the light emitting unit 2 and the focal plane 111 of the aspherical lens 11 in the x-direction and the distance L₂ to the focal plane 112 in the y-direction satisfy the following formula 3 and formula 4, respectively. An optical simulation software BeamPROP (available from Synopsys, Inc.) was utilized for the simulation.

$$\begin{matrix}[ Mathematical Expresion 14 ] & \\ {L}_{1} = \frac{{mP}_{1}^{2}}{2 λ} & ( Formula 3 )\end{matrix}$$

$$\begin{matrix}[ Mathematical Expresion 15 ] & \\ {L}_{2} = \frac{{nP}_{2}^{2}}{2 λ} & ( Formula 3 )\end{matrix}$$

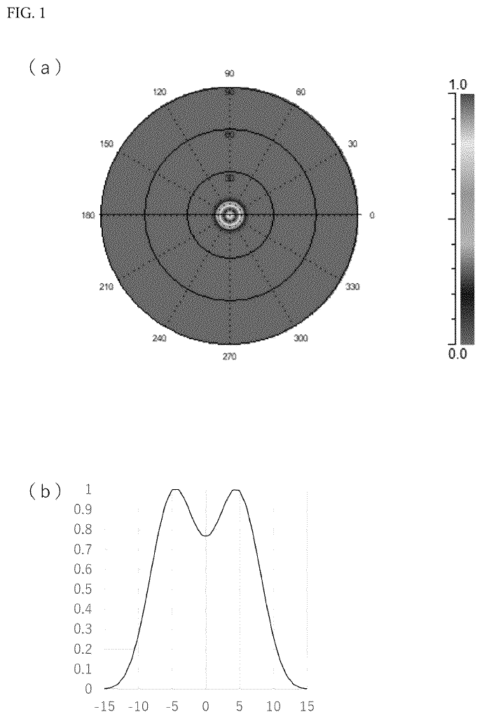

As for the light emitting unit 2, a singular light source which has a wavelength that is 940 nm (λ=0.94) and which emits light with a light distribution as illustrated in FIG. 1 was applied. As for the optical element 1, the aspherical lenses 11 each allowing light with the wavelength λ to pass therethrough were applied. As illustrated in FIG. 5C, the aspherical lenses 11 were arranged at intervals so as to satisfy: a refractive index that was 1.53; the focal distance f₁ that was 5 μm; the focal distance f₂ that was 75 m; the pitch P₁ that was 33 μm (P₁=33); and the pitch P₂ that was 32 μm (P₂=32). In this example, the light emitting unit 2 and the aspherical lenses 11 were placed at positions where L₁=1159 μm, L₂=1089 μm, and L₁+f₁=L₂+f₂=1164 μm when m=2 and n=2.

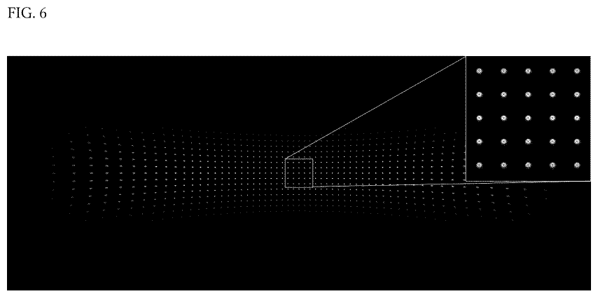

FIG. 6 is a projected plan that shows the simulation result. As shown in FIG. 6, dots became a quite sharp circular shape. Moreover, since the contrast was 84.2, it becomes clear that the contrast can be remarkably improved in comparison with conventional technologies.

### [Optical Element Production Method]

A production method of the optical element 1 will be described below. The aspherical lenses 11 of the optical element 1 can be produced in any schemes, but for example, can be produced by imprinting.

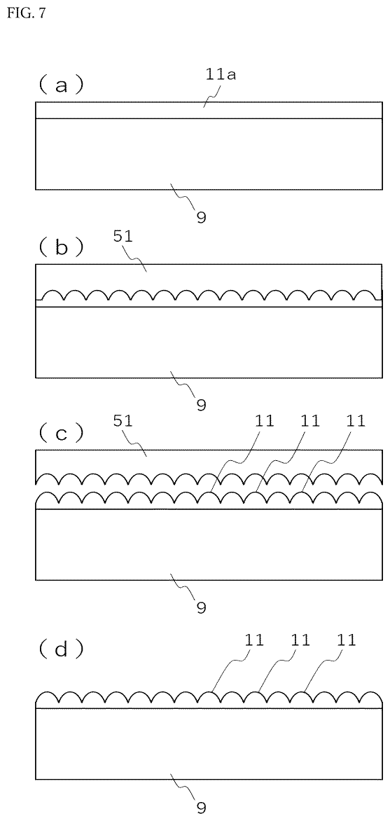

More specifically, first, the aspherical lenses 11 are formed on a substrate 9 by imprinting (an aspherical lens forming process). For example, as illustrated in FIG. 7A, a material 11a of the aspherical lenses 11 is applied on the substrate 9 at a predetermined film thickness by conventionally well-known scheme like spin coating (an applying process). The material 11a is not limited to any particular material as far as it can form the aspherical lens 11 allowing light with the wavelength λ to pass therethrough, and for example, a photo-curable polydimethylsiloxane (PDMS) is applicable. Next, as illustrated in FIG. 7B, a mold 51 that has a pattern with inverted shapes of the shapes of the respective aspherical lenses 11 is prepared, and is pressed on the applied material 11a of the aspherical lenses 11 to transfer the pattern (a transferring process). Subsequently, light like UV light is emitted so as to solidify the applied pattern (a solidifying process). Next, as illustrated in FIG. 7C, the mold 51 is demolded, and as illustrated in FIG. 7D, the aspherical lenses 11 are now formed.

### REFERENCE SIGNS LIST

1 Optical element
2 Light emitting unit
7 Light source
11 Aspherical lens
111 First focal plane
112 Second focal plane

1. An optical system device comprising:
an optical element comprising a plurality of aspherical lenses each allowing light with a wavelength λ to pass therethrough, the plurality of aspherical lenses being arranged at intervals; and
a light emitting unit comprising a light source that emits the light with the wavelength λ to the plurality of lenses,
wherein when m and n are each a natural number that is greater than equal to 1, f₁ is a focal distance by a cross-sectional shape of the aspherical lens perpendicular to a y-direction, f₂ is a focal distance by a cross-sectional shape of the aspherical lens perpendicular to an x-direction (f₁≠f₂), P₁ is a dimension of a pitch of the aspherical lens in the x-direction, and P₂ is a pitch of the aspherical lens in the y-direction, a distance L₁ between the light emitting unit and a first focal plane of the aspherical lens, and a distance L₂ to a second focal plane thereof satisfy the following formula 1 and formula 2, respectively.
$$\begin{matrix}[ Mathematical Expresion 1 ] & \\ \frac{{mP}_{1}^{2}}{2 λ} - {f}_{1} < {L}_{1} < \frac{{mP}_{1}^{2}}{2 λ} + {f}_{1} & ( Formula 1 )\end{matrix}$$
$$\begin{matrix}[ Mathematical Expresion 2 ] & \\ \frac{{nP}_{2}^{2}}{2 λ} - {f}_{2} < {L}_{2} < \frac{{nP}_{2}^{2}}{2 λ} + {f}_{2} . & ( Formula 2 )\end{matrix}$$

2. The optical system device according to claim 1, wherein:
a plurality of the light sources of the light emitting unit is arranged with a dimension of a pitch in the x-direction that is Pₓ, and a dimension of a pitch in the y-direction that is P_{y}; and
when j and λ are each a natural number that is greater than or equal to 1, Pₓ=jPᵢ or jPₓ=P₁ is satisfied and P_{y}=kP₂ or kP_{y}=P₂ is satisfied.

3. The optical system device according to claim 1, wherein the distances L₁ and L₂ satisfy the following formula 3 and formula 4, respectively.
$$\begin{matrix}[ Mathematical Expresion 3 ] & \\ {L}_{1} = \frac{{mP}_{1}^{2}}{2 λ} & ( Formula 3 )\end{matrix}$$
$$\begin{matrix}[ Mathematical Expresion 4 ] & \\ {L}_{2} = \frac{{nP}_{2}^{2}}{2 λ} . & ( Formula 4 )\end{matrix}$$

4. The optical system device according to claim 1, wherein a planar shape of the lens is a rectangular shape or a hexagonal shape.
